(19) United States
(12) Patent Application Publication
(10) Pub. No.: US 2010/0175500 A1
(43) Pub. Date: Jul. 15, 2010

(54) Cam Member Incorporated in Hinge Assembly for Electronic Device

(76) Inventor: Chao-Chi LIN, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/351,897

(22) Filed: Jan. 12, 2009

(51) Int. Cl. F16H 53/00; F16C 11/04; E05D 11/08

(52) U.S. Cl. 74/567

(57) ABSTRACT

A hinge assembly for an electronic device includes a pintle and a cam member connected to the pintle. The cam member is moveable on the pintle. The cam member and the pintle provide an area frictional engagement therebetween such that the cam member can easily move on the pintle and does not make an undesired noise as well as has a good ability to withstand stress.

### BACKGROUND OF THE INVENTION

1. Field of the Invention

The present invention relates to a cam member which is incorporated in a hinge assembly for an electronic device.

2. Description of the Related Art

FIG. 8 is a cross sectional view of a cam member 90 and a pintle 92 of a hinge assembly. The cam member 90 has a hole 91 extending therethrough and the pintle 92 is inserted through the hole 91 to connect to the cam member 90. Further, the cam member 90 is moveable on the pintle 92. Additionally, the hole 91 has a size marginally greater than the outer periphery of the pintle 92. Thus, the cam member 90 is adapted to move on the pintle 92 easily, due to less friction therebetween. Unfortunately, a drawback of this design is that the cam member 90 can shake with respect to the pintle 92 and which will results an undesired noise.

Taiwan Pat No. M309841 is an attempt to disclose a cam member of a hinge assembly which alleviates the aforementioned problem. The cam member includes a pivot hole comprised of a pair of arcuate walls opposite to each other and a pair of planar walls joining the pair of arcuate walls, and each arcuate wall has a protruded point extended therefrom, or alternatively, each planar wall has two protruded points extended therefrom. A pintle includes a pair of arcuate walls and a pair of planar walls, and when the pintle is installed in the pivot hole each of the protruded points and the pintle provide a point frictional engagement therebetween, respectively. But a drawback is that these protruded points are still not effective for preventing the cam member from making an undesired noise. Additionally, these protruded points are liable to get damaged under intense stress in the hinge assembly.

Taiwan Patent No. M322486 is another attempt to disclose a cam member of a hinge assembly which alleviates the aforementioned problem. The cam member has a hole and protruded ridges disposed in the hole. Each protruded ridge has an apex, and when a pintle is installed into the hole, the apex of each protruded ridge engages the pintle. Because each protruded ridge has an extent, so the apex is in the form of a line. Thus, the protruded ridges and the pintle provide a line frictional engagement therebetween, respectively. But a drawback is that these protruded ridges are still not effective for preventing the cam member from making an undesired noise. Additionally, these protruded points are liable to get damaged under intense stress in the hinge assembly.

The present invention is, therefore, intended to obviate or at least alleviate the problems encountered in the prior art.

### SUMMARY OF THE INVENTION

According to the present invention, a cam member is incorporated in a hinge assembly for an electronic device, with the hinge assembly including a pintle connected to the cam member, and with the cam member moveable on the pintle. The cam member includes a first face and a second face axially spaced from the first face. A hole extends through the first and second faces and through which the pintle is inserted. The hole includes a pair of substantially planar surfaces opposite to each other and a pair of substantially arcuate surfaces opposite to each other. A block is disposed on one of the planar surface and arcuate surface and includes a top edge defining an area in contact with an area of the pintle.

It is an objective of the present invention that the cam member and the pintle provide an area frictional engagement therebetween.

It is another objective of the present invention that the movement of the cam member with respect to the pintle is facilitated.

It is yet another objective of the present invention that the cam member does not make an undesired noise during operation thereof.

It is a further objective of the present invention that the cam member has a good ability to withstand intense stress.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

For the present disclosure to be easily understood and readily practiced, the present disclosure will now be described in conjunction with the following figures, wherein;

FIG. 1 is a perspective view of a cam member in accordance with a first embodiment of the present invention.

FIG. 2 is a side elevation view of the cam member shown in FIG. 1.

FIG. 3 is a perspective view showing the cam member of FIG. 1 is connected to a pintle of a hinge assembly.

FIG. 4 is a cross-sectional view taken along line 4-4 of FIG. 3.

FIG. 5 is a perspective view of a cam member in accordance with a second embodiment of the present invention.

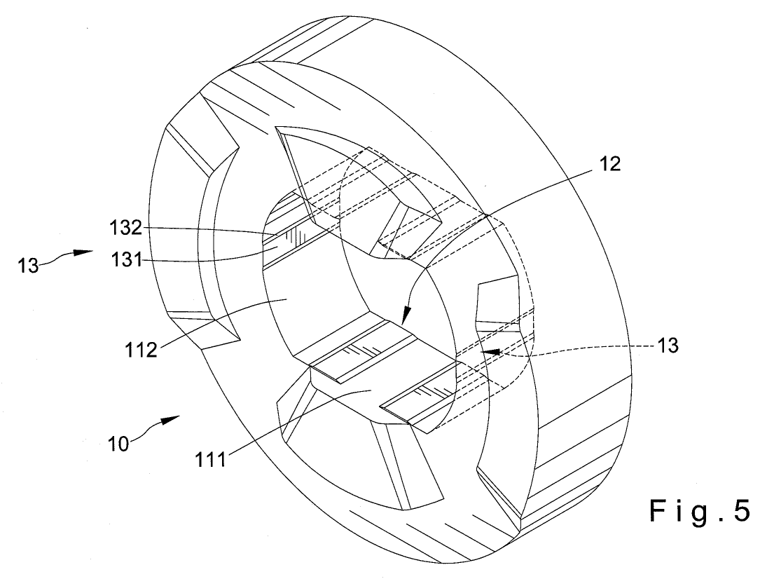

FIG. 6 is a side elevation view of the cam member shown in FIG. 5.

FIG. 7 is a cross-sectional view showing the cam member of FIG. 5 is connected to a pintle of a hinge assembly.

FIG. 8 is a cross-sectional view showing a conventional cam member and pintle, and with the cam member connected to the pintle.

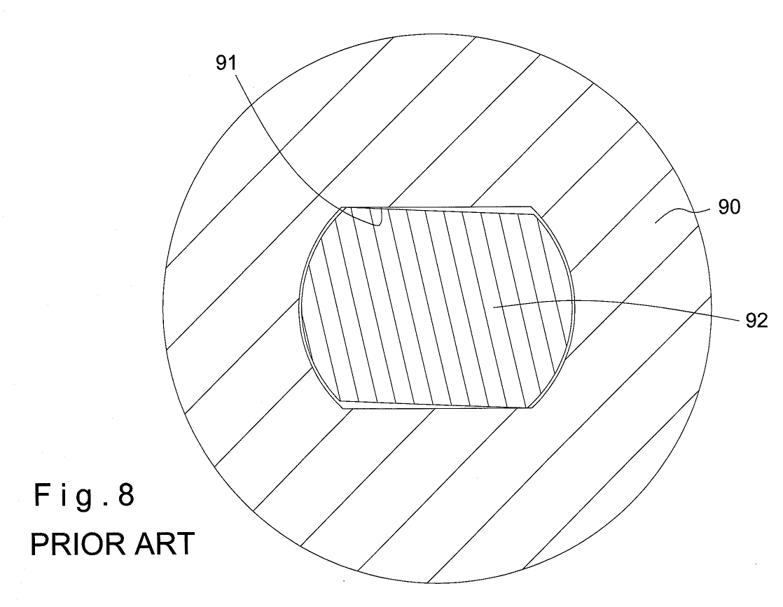

### DETAILED DESCRIPTION OF THE PREFERRED EMBODIMENT

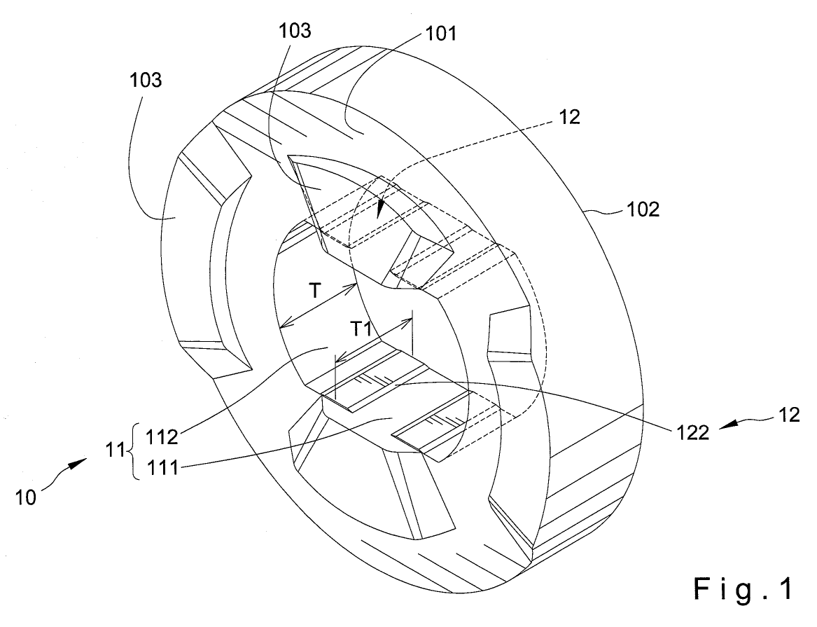

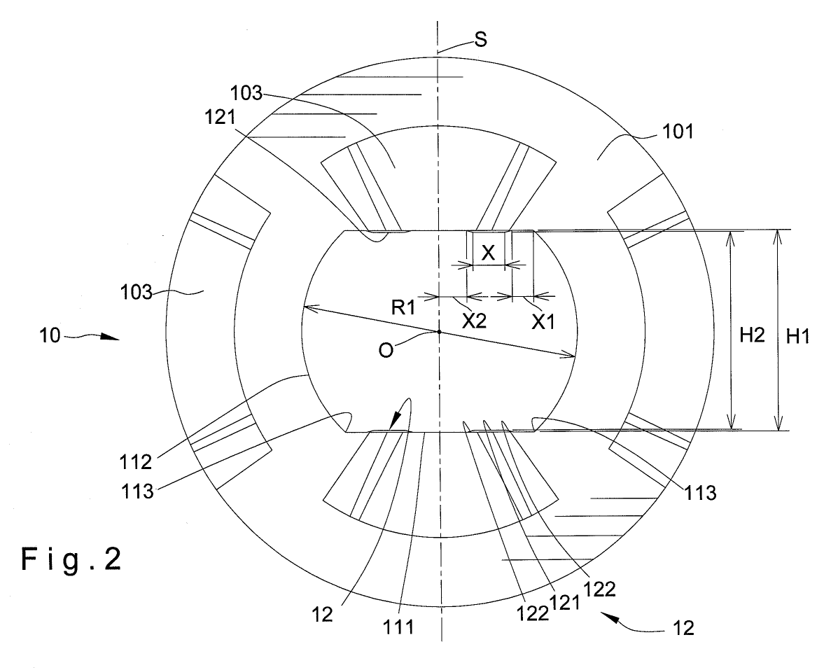

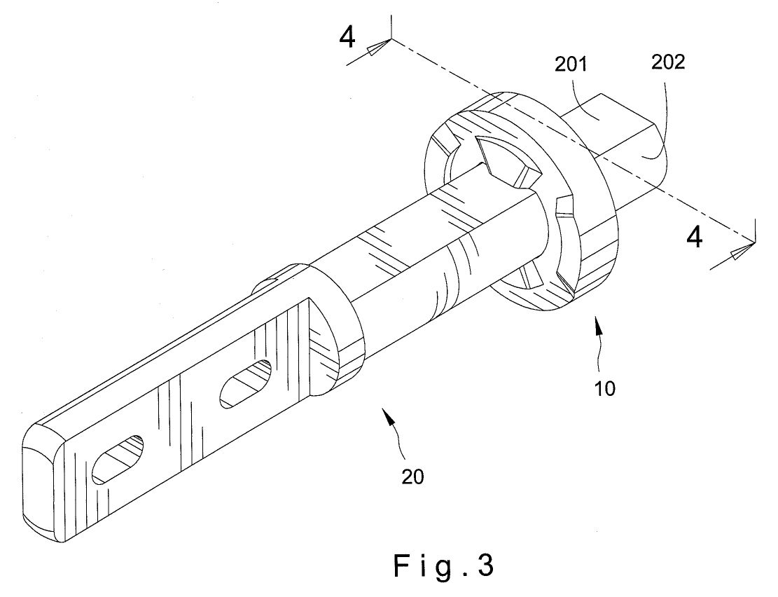

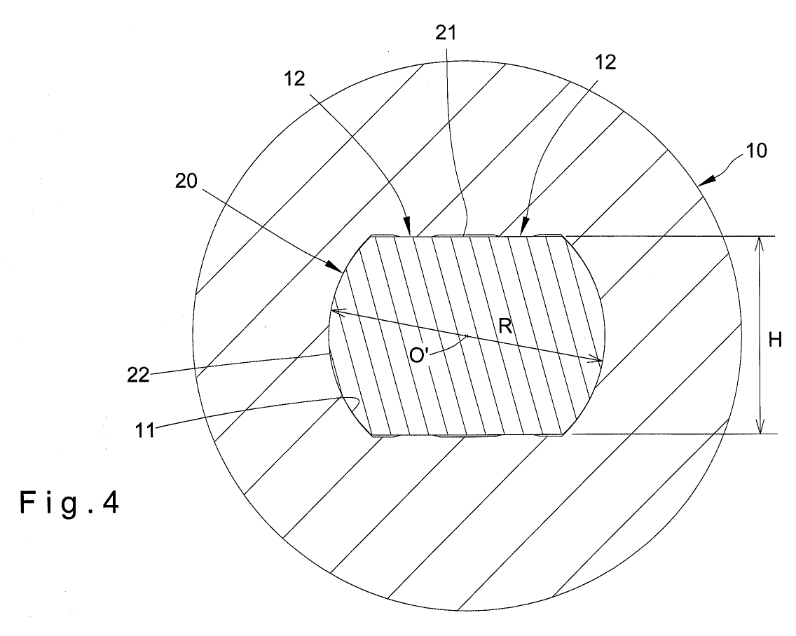

FIGS. 1 through 4 show a cam member 10 in accordance with a first embodiment of the present invention. The cam member 10 is adapted to be incorporated in a hinge assembly. The hinge assembly has a use in an electronic device. The hinge assembly includes a pintle 20 connected to the cam member 10 and the cam member 10 is moveable on the pintle 20.

The cam member 10 includes a first face 101 and a second face 102 axially spaced from the first face 101 at a distance T. Further, a plurality of protrusions 103 is radially disposed on the first face 101. Each of the protrusions 103 includes a substantially flat edge elevated from the first face 101 and two sloped edges extending from two ends of the flat edge, respectively. Further, a hole 11 extends through the first and second faces 101 and 102 and through which the pintle 20 is inserted. The hole 11 includes a pair of substantially planar surfaces 111 opposite to each other and a pair of substantially arcuate surfaces 112 opposite to each other. Additionally, the hole 11 defines a first imaginary point O and an imaginary axis S extending through the first imaginary point O and symmetrically dividing one of the pair of planar surfaces 111 and the pair of arcuate surfaces 112.

The cam member 10 includes a block 12 disposed on one of the planar surface 111 and arcuate surface 112 to engage with the pintle 20. In this embodiment, the pair of the planar surfaces 111 include at least a pair of blocks 12 respectively, and the at least two blocks 12 are opposite to each other. Further, the two planar surfaces 111 are spaced at a first distance H1, and the at least two blocks 12 are spaced at a second distance H2. Additionally, the pintle 20 includes two flat sides 201 spaced at a third distance H, and the second distance H2 is marginally greater than the third distance H, and the first distance H1 is greater than the third distance H.

Moreover, the block 12 has a longitudinal length T1. Preferably, the longitudinal length T1 equals to the distance T.

Moreover, the block 12 includes a top edge 121 and two sloped side edges 122 extending from two ends of the top edge 121.

Moreover, the block 12 is spaced from a corner 113 between one planar surface 111 and one arcuate surface 112 at a first distance X1 and is spaced from the imaginary axis S at a distance X2. Additionally, the top edge 121 of the block 12 includes a width X greater than either the first and second distances X1 and X2 so as to enable the cam member 10 and the pintle 20 provide an area frictional engagement.

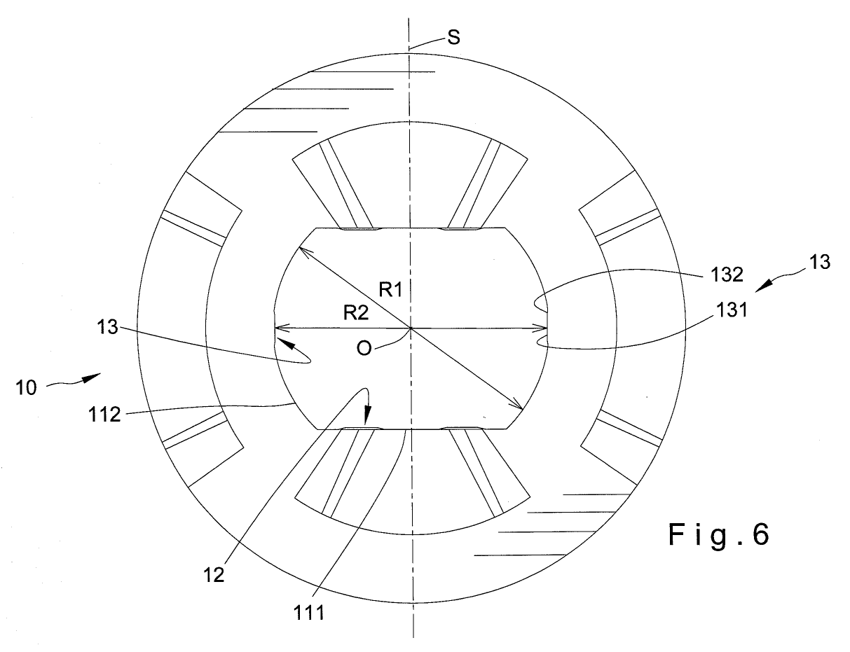

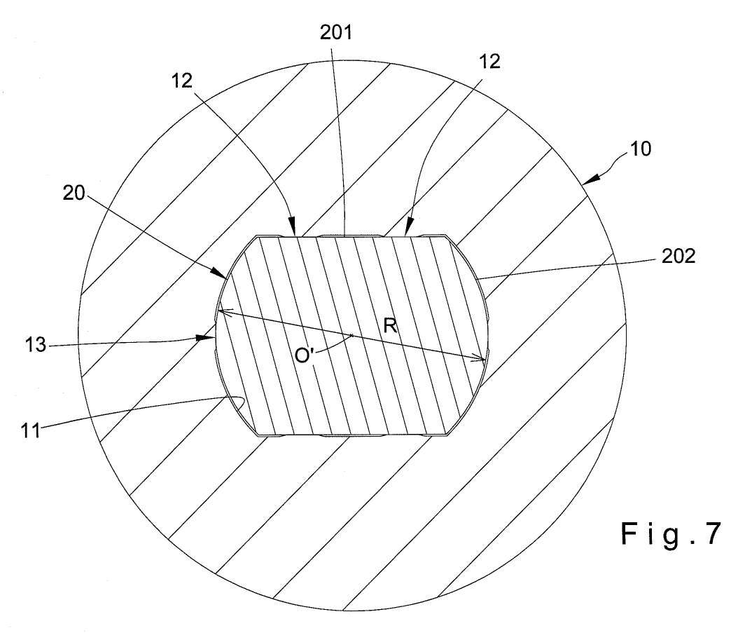

Referring to FIGS. 6 and 7, a cam member 10 in accordance with a second embodiment of the present invention is similar to the first embodiment except that it further includes two blocks 13 on the pair of the arcuate surfaces 112 respectively. The two blocks 13 are opposite to each other. Each of the block 13 includes a top edge 131 and two sloped side edges 132 extending from two ends of the top edge 131.

The hole 11 defines a first imaginary point O. The pair of the arcuate surfaces 112 define a first imaginary line extending from one of the arcuate surfaces 112 and through the first imaginary point O to the other of the arcuate surfaces 112. The two blocks 13 define a second imaginary line extending from one of the two blocks 13 and through the first imaginary point O to the other of the blocks 13.

The pintle 20 includes two arcuate sides 202 and defines a second imaginary point O′ substantially corresponding to the first imaginary point O and a third imaginary line extending from one of the arcuate sides 202 and through the second imaginary point O′ to the other of the arcuate sides 202.

The first, second and thirds imaginary lines define first, second and third radial distances R1, R2, R, respectively, and the second radial distance R2 is marginally greater than the third radial distance R, and the first radial distance R1 is greater than the third radial distance R.

Based on the forgoing, it is therefore an objective of the present invention that the cam member 10 and the pintle 20 provide an area frictional engagement therebetween.

It is another objective of the present invention that the movement of the cam member 10 with respect to the pintle 20 is facilitated.

It is yet another objective of the present invention that the cam member 10 does not make an undesired noise during operation thereof.

It is a further objective of the present invention that the cam member 10 has a good ability to withstand intense stress.

While the specific embodiments have been illustrated and described, numerous modifications come to mind without significantly departing from the spirit of invention and the scope of invention is only limited by the scope of accompanying claims.

What is claimed is:

1. A cam member is incorporated in a hinge assembly for an electronic device, with the hinge assembly including a pintle connected to the cam member, and with the cam member moveable on the pintle, and the cam member comprising:
a first face and a second face axially spaced from the first face;
a hole extending through the first and second faces and through which the pintle is inserted, and the hole including a pair of substantially planar surfaces opposite to each other and a pair of substantially arcuate surfaces opposite to each other; and
a block disposed on one of the planar surface and arcuate surface and including a top edge defining an area in contact with an area of the pintle so as to enable the cam member and the pintle to provide an area frictional engagement therebetween.

2. The cam member as claimed in claim 1 wherein the pair of the planar surfaces include two blocks respectively, and with the two blocks opposite to each other, and wherein the planar surfaces are spaced at a first distance, and the blocks are spaced at a second distance, and wherein the pintle includes two flat sides spaced at a third distance, and wherein the second distance is marginally greater than the third distance, and the first distance is greater than the third distance.

3. The cam member as claimed in claim 1 wherein the pair of the arcuate surfaces include two blocks respectively, and with the two blocks opposite to each other, and wherein the hole defines a first imaginary point and the pair of the arcuate surfaces define a first imaginary line extending from one of the arcuate surfaces and through the first imaginary point to the other of the arcuate surfaces, and the two blocks define a second imaginary line extending from one of the two blocks and through the first imaginary point to the other of the blocks, and wherein the pintle includes two arcuate sides and defines a second imaginary point and a third imaginary line extending from one of the arcuate sides and through the second imaginary point to the other of the arcuate sides, and with the first and second imaginary points substantially corresponding to each other, and wherein the first, second and thirds imaginary lines define first, second and third radial distances, with the second radial distance marginally greater than the third radial distance, and the first radial distance greater than the third distance.

4. The cam member as claimed in claim 2 wherein the pair of the arcuate surfaces include two blocks respectively, and with the two blocks opposite to each other, and wherein the hole defines a first imaginary point and the pair of the arcuate surfaces define a first imaginary line extending from one of the arcuate surfaces and through the first imaginary point to the other of the arcuate surfaces, and the two blocks define a second imaginary line extending from one of the two blocks and through the first imaginary point to the other of the blocks, and wherein the pintle includes two arcuate sides and defines a second imaginary point and a third imaginary line extending from one of the arcuate sides and through the second imaginary point to the other of the arcuate sides, and with the first and second imaginary points substantially corresponding to each other, and wherein the first, second and third imaginary lines define first, second and third radial distances, with the second radial distance marginally greater than the third radial distance, and the first radial distance greater than the third distance.

5. The cam member as claimed in claim 1 wherein the hole defines a first imaginary point and an imaginary axis extending through the first imaginary point and symmetrically dividing one of the pair of planar surfaces and the pair of arcuate surfaces.

6. The cam member as claimed in claim 2 wherein the hole defines a first imaginary point and an imaginary axis extending through the first imaginary point and symmetrically dividing one of the pair of planar surfaces and the pair of arcuate surfaces.

7. The cam member as claimed in claim 3 wherein the hole defines an imaginary axis extending through the first imaginary point and symmetrically dividing one of the pair of planar surfaces and the pair of arcuate surfaces.

8. The cam member as claimed in claim 4 wherein the hole defines an imaginary axis extending through the first imaginary point and symmetrically dividing one of the pair of planar surfaces and the pair of arcuate surfaces.

9. The cam member as claimed in claim 1 wherein the block is spaced from a corner between one planar surface and one arcuate surface at a first distance and the top edge thereof includes a width, and with the width greater than the first distance so as to enable the cam member and the pintle provide an area frictional engagement.

10. The cam member as claimed in claim 5 wherein the block is spaced from a corner between one planar surface and one arcuate surface at a first distance and is spaced from the imaginary axis at a distance and the top edge thereof includes a width, and with the width greater than either the first and second distances so as to enable the cam member and the pintle provide an area frictional engagement.

11. The cam member as claimed in claim 6 wherein the block is spaced from a corner between one planar surface and one arcuate surface at a first distance and is spaced from the imaginary axis at a distance and the top edge thereof includes a width, and with the width greater than either the first and second distances so as to enable the cam member and the pintle provide an area frictional engagement.

12. The cam member as claimed in claim 7 wherein the block is spaced from a corner between one planar surface and one arcuate surface at a first distance and is spaced from the imaginary axis at a distance and the top edge thereof includes a width, and with the width greater than either the first and second distances so as to enable the cam member and the pintle provide an area frictional engagement.

13. The cam member as claimed in claim 8 wherein the block is spaced from a corner between one planar surface and one arcuate surface at a first distance and is spaced from the imaginary axis at a distance and the top edge thereof includes a width, and with the width greater than either the first and second distances so as to enable the cam member and the pintle provide an area frictional engagement.

14. The cam member as claimed in claim 1 wherein the block includes two sloped side edges extending from two ends of the top edge.
